(19) United States
(12) Patent Application Publication
(10) Pub. No.: US 2020/0187314 A1
(43) Pub. Date: Jun. 11, 2020

(54) MULTI-FEED MICROWAVE OVEN WITH IMPROVED CRISP FUNCTION

(71) Applicants: WHIRLPOOL CORPORATION, BENTON HARBOR, MI (US); PANASONIC CORPORATION, Osaka (JP)

(72) Inventor: Giovanni Dore, Valentano (IT)

(73) Assignee: WHIRLPOOL CORPORATION, BENTON HARBOR, MI (US)

(21) Appl. No.: 16/309,233

(22) PCT Filed: Jun. 28, 2016
(86) PCT No.: PCT/US2016/039835

§ 371 Date: Dec. 12, 2018

(51) Int. Cl. H05B 6/64; H05B 6/72; H05B 6/70; H05B 6/68

(52) U.S. Cl. CPC H05B 6/6494; H05B 6/725; H05B 6/70; H05B 6/6408; H05B 6/688; H05B 6/687; H05B 6/6435; H05B 6/686

(57) ABSTRACT

A microwave oven is provided herein and includes a cavity. A first microwave supply system is configured to supply microwaves to a bottom of the cavity for energizing a crisp function. A second microwave supply system is configured to supply microwaves to the cavity for exciting cavity modes. A heating system is configured to provide a broiling function to the cavity. A control unit is configured to control the first microwave supply system, the second microwave supply system, and the heating system based on a mode of operation selected via a user interface.

### BACKGROUND

The present disclosure generally relates to a cooking apparatus, and more particularly, to a microwave oven having multiple feeds for heating a cavity of the microwave oven.

The art of microwave heating involves the feeding of microwave energy into a cavity. Although the basic function of a microwave oven is to heat food by dielectric heating (i.e., via direct acting microwaves absorbed in the food), microwave ovens have been developed to include additional kinds of cooking capabilities, such as a crisp (or browning) function, thereby enabling preparation of various types of food items and providing new culinary effects.

A drawback of many current microwave ovens is that their design may be optimized for a specific function (typically the directly acting microwaves) at the detriment of another function (typically the crisp function). For instance, the crisp function in such microwave ovens is usually obtained via the same feeding system used for direct acting microwaves, and as a result, the performance of the crisp function may suffer.

### SUMMARY

According to one aspect, a microwave oven is provided and includes a cavity. A first microwave supply system is configured to supply microwaves to a bottom of the cavity for energizing a crisp function. A second microwave supply system is configured to supply microwaves to the cavity for exciting cavity modes. A heating system is configured to provide a broiling function to the cavity. A control unit is configured to control the first microwave supply system, the second microwave supply system, and the heating system based on a mode of operation selected via a user interface.

According to another aspect, a microwave oven is provided and includes a cavity having a bottom tray. A crisp plate is in thermal contact with the bottom tray. A first microwave supply system is provided and includes a first microwave generator for generating microwaves and a rotatable antenna for receiving the generated microwaves via a first feeding port and supplying the generated microwaves under the bottom tray for heating a sole of the crisp plate to a Curie point. A second microwave supply system is provided and includes a second feeding port provided at a first side wall of the cavity, a third feeding port provided at a second side wall of the cavity, wherein the second side wall is opposite to the first side wall, and at least one microwave generator for generating microwaves supplied to the cavity via the second and third feeding ports. A heating system is configured to provide a broiling function to the cavity. A control unit is configured to activate the first microwave generator, the at least one microwave generator, and the heating system to provide a crisp function to the cavity.

According to yet another aspect, a method of crisping a food item in a microwave oven is provided. The method includes the steps of providing a bottom tray in a cavity of the microwave oven; providing a crisp plate in thermal contact with the bottom tray; supplying microwaves to a bottom of a cavity for heating a sole of the crisp plate to a Curie point; supplying microwaves to the cavity for exciting cavity modes; and activating a heating system to provide a broiling function to the cavity.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 illustrates a microwave oven having a rotatable antenna for providing a crisp function;

FIG. 2 is a schematic diagram of the microwave shown in FIG. 1 and a control unit for selectively controlling a first microwave supply system, a second microwave supply system, and a heating system based on information received from a user interface; and

FIG. 3 is a flow diagram of a method of crisping a food, the method being implemented by the microwave oven shown in FIGS. 1 and 2.

### DETAILED DESCRIPTION

It is to be understood that the specific devices and processes illustrated in the attached drawings, and described in the following specification are simply exemplary embodiments of the inventive concepts defined in the appended claims. Hence, other physical characteristics relating to the embodiments disclosed herein are not to be considered as limiting, unless the claims expressly state otherwise.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

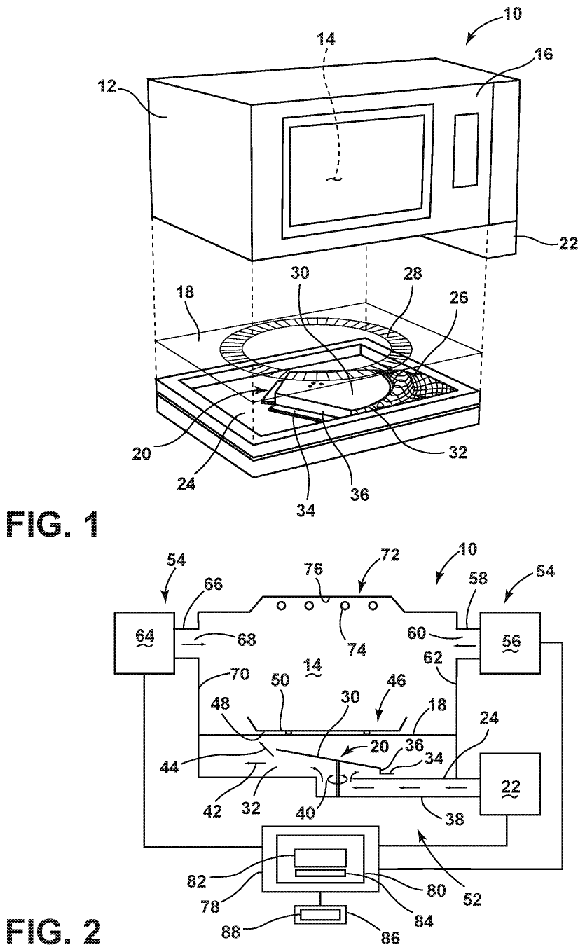

With reference to FIG. 1, there is shown a microwave cooking apparatus, e.g., a microwave oven 10, having features and functions according to one embodiment. The microwave oven 10 includes a cabinet 12 defining a cavity 14 for electromagnetically heating and/or cooking foodstuff in the cavity 14. A door 16 is movably mounted to the cabinet 12 to allow user access to the interior of the cavity 14 for placement and retrieval of food inside the cavity 14. The cavity 14 is equipped with a bottom tray 18 for receiving a food item or an accessory containing the food item. The bottom tray 18 is represented as a horizontal plane covering a whole section of the cavity 14 and may be constructed of glass or other equivalent microwave transparent material. However, it will be appreciated that the bottom tray 18 may be smaller than the whole section of the cavity 14, if desired.

With continued reference to FIG. 1, the microwave oven 10 also includes a rotatable antenna 20 and a first microwave generator 22. The microwave generator 22 is configured to generate microwaves that are supplied to the rotatable antenna 20 via a feeding port (not shown). The rotatable antenna 20 is arranged at a bottom 24 of the cavity 14 for supplying the generated microwaves toward the bottom tray 18. In operation, the rotatable antenna 20 is configured to produce at least one radiating lobe pointing towards the bottom tray 18 such that the intersection between the radiating lobe and the bottom tray 18 forms a hot spot 26, thereby forming a ring-shaped heating pattern 28 in the bottom tray 18 due to rotation of the rotatable antenna 20.

Advantageously, the rotatable antenna 20 may be configured to produce a radiating lobe such that the ring-shaped heating pattern 28 covers about 10 to 50 percent of the bottom tray 18. In particular, the rotatable antenna 20 may be configured to produce a radiating lobe pointing in a direction forming an angle in the range of 0-90 degrees, and more preferably in the range of 30-60 degrees, with the bottom tray 18. Depending on the size of the rotatable antenna 20 relative to the size of the bottom tray 18 or depending on the location of the antenna opening through which microwaves are generated at the bottom of the cavity 14 relative to the position of the bottom tray 18, the radiating lobe may be directed perpendicular to the bottom tray 18 or included such that the radiating lobe points at the periphery of the bottom tray 18. As the electromagnetic field is concentrated at a specific point or hot spot 26 of the bottom tray 18, it is advantageous if the radiating lobe is not directed towards the center of the bottom tray 18 in order to avoid local overheating. Indeed, if the radiating lobe points too close to the center of the bottom tray 18, the coverage area of the heating pattern will be limited and the uniformity of a crisp function, for example, will be relatively poor. It is thus particularly advantageous if the radiating lobe is inclined and points at the periphery of the bottom tray 18 since a relatively large ring-shaped heating pattern 28 may then be created in the bottom tray 18 under rotation of the rotatable antenna 20.

In the depicted embodiment of FIG. 1, the rotatable antenna 20 includes a sector-shaped panel 30 arranged at a distance from the bottom 24 of the cavity 14 and providing at least one opening 32 through which the generated microwaves are supplied to the bottom tray 18. In particular, the distance between the bottom 24 of the cavity 14 and the sector-shaped panel 30 of the rotatable antenna 20 together with the sector geometry defines the level of the microwave power supplied from the rotatable antenna 20 via the opening 32 to the cavity 14. Thus, the distance between the bottom 24 of the cavity 14 and the sector-shaped panel 30 and the sector geometry itself are parameters that can be used for designing the rotatable antenna 20 and improving the crisp function of the microwave oven 10. In particular, the rotatable antenna 20 may be equipped with at least one (substantially horizontal) lateral wing 34 connected to the sector-shaped panel 30 via a (substantially vertical) side wall 36 for providing the opening 32. The height of the side wall 36 may then determine the level of microwave power supplied by the rotatable antenna 20.

With reference to FIG. 2, a schematic view of the microwave oven 10 is shown according to one embodiment. In particular, FIG. 2 shows the sector-shaped panel 30 disposed at an angle relative to the bottom 24 of the cavity 14. The angular positioning of the sector-shaped panel 30 relative to the bottom 24 of the cavity 14 defines the direction at which the radiating lobe exits the opening 32. Accordingly, the sector-shaped panel 30 may be positioned such that the radiating lobe points at the periphery (or any other advantageous location) of the bottom tray 18. In alternative embodiments, the sector-shaped panel 30 may be curved or substantially horizontal to be in parallel with the bottom 24 of the cavity 14. With respect to FIG. 2, the arrows generally represent the direction of propagation of the generated microwaves and are provided for the sake of illustration. In this specific example, the generated microwaves come from the right hand side and propagate in a transmission line 38, which is connected to the first microwave generator 22 and is provided to transmit microwaves generated therefrom to the rotatable antenna 20 via a first feeding port 40 formed in the bottom 24 of the cavity 14. The microwaves are then transmitted from the rotatable antenna 20 via the opening 32. The transmission line 38 may be a waveguide, a coaxial cable, and/or a strip line, for example.

Depending on the design of the rotatable antenna 20 and its boundary conditions (e.g., the disposition of the bottom 24 of the cavity 14), the opening 32 may result in one or several radiating lobes propagating in a general horizontal and/or inclined direction (e.g., horizontal direction 42, inclined direction 44) relative to the bottom 24 of the cavity 14. Accordingly, the a portion of the microwaves supplied by the rotatable antenna 20 may be provided to energize a crisp function while the remaining portion of the microwaves may be provided to excite cavity modes at the bottom 24 of the cavity. While the rotatable antenna 20 has been shown and described herein as having a single opening 32, it is to be understood that the rotatable antenna 20 may be configured with multiple openings. For example, additional openings may be formed through the sector-shaped panel 30. In so doing, additional hot spots and accompanying ring-shaped heating patterns may be created at other locations of the bottom tray 18 to improve the uniformity of the crisp function.

With continued reference to FIG. 2, a crisp plate 46 is disposed atop the bottom tray 18 and is arranged to receive a food item thereon. The crisp plate 46 includes a first member 48 configured to absorb microwave energy and transform the microwave energy into heat, and a second member 50 arranged in thermal contact with the first member 48. The first member 48 corresponds to the underside, otherwise known as the sole, of the crisp plate 46 and the second member 50 generally corresponds to the upper side of the crisp plate 46 and receives the food item to be crisped thereon. Generally, the second member 50 may be constructed of an aluminum or steel plate having a relatively small thermal mass and good conductivity. In some embodiments, the second member 50 may also include a non-stick coating. Aluminum generally has the advantage of having relatively high heat conduction as compared to steel. However, steel is generally a more economical alternative.

The first member 48 may be a ceramic such as rubber-embedded ferrite (e.g., in a proportion of about 75% ferrite and 25% silicon dioxide). The ferrite material has a Curie point at which absorption of the microwaves therein ceases. The characteristics for absorption of the microwaves in the ferrite material may be varied by altering the thickness of the first member 48 and/or the composition thereof. Generally the temperature of the second member 50 of the crisp plate 46 that comes into contact with the food item stabilizes in a temperature range of 130-230 degrees Celsius. While the crisp plate 46 is illustrated in FIG. 2 to be generally circular, it is to be understood that the crisp plate 46 may be rectangular or some other shape without adversely impacting the crisp function of the microwave oven 10. Furthermore, it is to be understood that the crisp plate 46 may be removable or otherwise integrated with the cavity 14 and/or bottom tray 18.

With further reference to FIG. 2, the microwave oven 10 includes a first microwave supply system 52 having, as components, the microwave generator 22, transmission line 38, feeding port 40, and rotatable antenna 20. As described herein, the aforementioned components of the first microwave supply system 52 may be configured to supply microwaves under the bottom tray 18 for energizing a crisp function in the cavity 14. A second microwave supply system 54 is configured to supply microwaves to the cavity 14 for exciting cavity modes. The second microwave supply system 54 includes a second microwave generator 56 connected to a second transmission line 58 for supplying microwaves to the cavity via a second feeding port 60 provided at an upper extent of a first side wall 62. The second microwave supply system 54 also includes a third microwave generator 64 connected to a third transmission line 66 for supplying microwaves to the cavity via a third feeding port 68 provided at an upper extent of a second side wall 70 positioned opposite to the first side wall 62. The second and third transmission lines 58, 66 may each correspond to a waveguide, a coaxial cable, and/or a strip line, for example. The second and third feeding ports 60, 68 may be provided at similar or different heights on their respective side walls 62, 70. In alternative embodiments, a single microwave generator may be used to supply microwaves to the cavity 14 via the second and third feeding ports 60, 68. It is also contemplated that the second and/or third feeding ports 60, 68 may supply microwaves to the cavity 14 provided by the first microwave generator 22. Accordingly, in alternative embodiments, the first microwave generator 22 may include a generating block having a plurality of microwave sources.

In the presently depicted embodiment, the first, second, and/or third microwave generators 22, 56, 64 are solid-state based microwave generators, which advantageously enable controlling of the frequency and phase of the generated microwaves, controlling the output power of the microwave generator, and an inherent narrow-band spectrum. The frequencies of the microwaves that are emitted from a solid-state based microwave generator usually include a narrow range of frequencies such as 2.4 to 2.5 GHz. However, it is to be understood that other frequency ranges are possible as well.

The microwave oven 10 further includes a heating system 72 having a heating element 74 arranged at a ceiling 76 of the cavity 14 for providing an additional source of heating to the cavity 14, thereby increasing the cooking capability of the microwave oven 10. The heating element 74 may be configured to provide a broiling function to the cavity 14 based on direct heat or forced convection, and may include, for example, a grill tube, a quartz tube, a halogen-radiation source, or an infrared-radiating heater.

As further shown in FIG. 2, the microwave oven 10 includes a control unit 78 for controlling the first microwave generator 22, the second microwave generator 56, the third microwave generator 64, and the heating element 74. In operation, the control unit 78 determines which of the first microwave generator 22, the second microwave generator 56, the third microwave generator 64, and the heating element 74 is to be activated based on a food item type and/or a mode of operation. For example, the control unit 78 may be configured to separately select and control a set of actuations (e.g., frequency, amplitude, phase, and power) of the microwaves supplied by the first, second, and third microwave generators 22, 56, 64, respectively, thereby enabling excitation of a predetermined electromagnetic (EM) field in order to heat a food item in an even or uneven manner depending on the selected mode of operation. Additionally or alternatively, the control unit 78 may control the activation of the heating element 74 and/or any power supply connected thereto. In some embodiments, the control unit 78 may additionally be configured to predict an EM field pattern distribution and a relative power dissipated in the first, second, and third microwave generators 22, 56, 64 as well as other components of the microwave oven 10 (e.g., bottom tray 18, door 16, and crisp plate 46). The control unit 78 may include a memory 80 storing instructions 82 thereon that are executed by a processor 84. The instructions 82 may enable the determination of the mode of operation such that a balance can be achieved between the different energy sources of the microwave oven 10. Accordingly, the control unit 78 may function as a shared controller between the foregoing energy sources. However, it is contemplated that more than one control unit may be provided and operably coupled to the first microwave generator 22, the second microwave generator 56, the third microwave generator 64, and the heating element 74, in any combination.

According to the depicted embodiment of FIG. 2, a user interface 86 is provided and is in communication with the control unit 78. The user interface 86 may include a touchscreen display 88 or control panel that enables a user to input information to the control unit 78. The information may relate to the selection of a mode of operation of the microwave oven 10. In turn, the control unit 78 controls the different energy sources according to the inputted information. As described herein, the determination of the mode of operation may be implemented via instructions 82 stored in the memory 80 of the control unit 78. It is contemplated that the instructions 82 may include look-up tables, thereby enabling the control unit 78 to easily retrieve the appropriate mode of operation based on information entered by the user via the user interface 86.

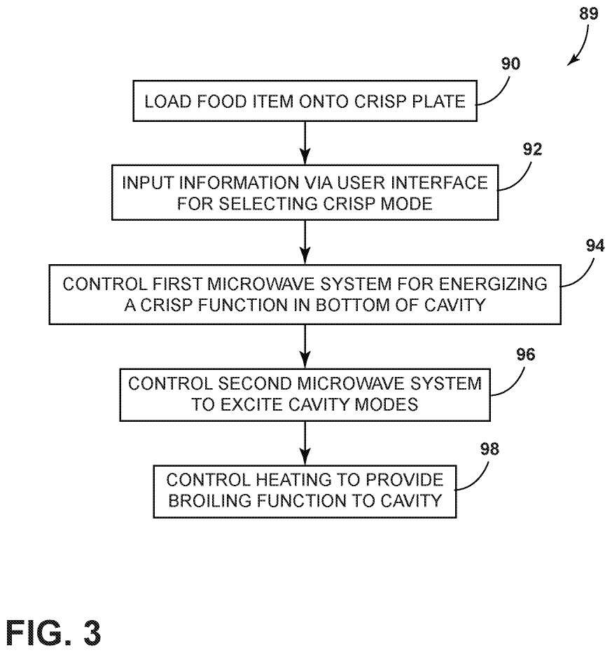

Referring to Table 1 below, several modes of operation are shown for the purposes of illustration. Each mode of operation may be selected via the user interface 86 and is implemented by the control unit 78. As will be described below, the inclusion of the first microwave supply system 52, the second microwave supply system 54, and the heating system 72 impart greater versatility to the microwave oven 10, thereby enabling a user to achieve a variety of culinary effects. As shown, the microwave oven 10 includes a crisp mode that will be described in greater detail with reference to FIG. 3, which illustrates a method 89 of crisping a food item. The method 89 may be implemented by the microwave oven 10 described herein with respect to FIGS. 1 and 2 and may be embodied as a subset of instructions 82 stored on the memory 80 of the control unit 78.

TABLE 1
Modes of Operation

| Mode of | First Microwave | Second Microwave | |
|---|---|---|---|
| Operation | Supply System | Supply System | Heating System |
| Crisp Mode | Activated | Activated | Activated |
| Defrost Mode | Deactivated | Activated | Deactivated |
| Even Heating | Activated | Activated | Deactivated |
| Mode | | | |
| Controlled | Deactivated | Activated | Activated |
| Heating Mode | | | |
| Bottom | Activated | Deactivated | Deactivated |
| Heating | | | |
| Mode | | | |

With reference to FIG. 3, at step 90, a user loads a food item, such as a frozen pizza, onto the crisp plate 46 provided atop the bottom tray 18 located in the cavity 14 of the microwave oven 10. At step 92, the user inputs information via the user interface 86 for selecting a crisp mode. The inputted information may also specify a food item type, e.g., frozen pizza. In response, at step 94, the control unit 78 controls the first microwave supply system 52 for energizing a crisp function in the bottom 24 of the cavity 14. For example, the control unit 78 may activate the first microwave generator 22 to supply microwaves to the rotatable antenna 20, which, in turn, distributes the microwaves under the bottom tray 18 for heating the sole of the crisp plate 46 to its Curie point. At step 96, the control unit 78 controls the second microwave supply system 54 to excite cavity modes in the cavity 14. For example, the control unit 78 may activate the second and third microwave generators 56, 64 to supply microwaves into the cavity 14 via their respective feeding ports 60, 68 to provide heating and preparation of the core of the frozen pizza. At step 98, the control unit 78 controls the heating system 72 to provide a broiling function to the cavity 14. For example, the control unit 78 may activate the heating element 74 to provide heating to melt the ingredients on top of the frozen pizza. While steps 94-98 have been described herein in a step-wise manner, it should be appreciated that they may be performed concurrently or sequentially in any order.

With reference back to Table 1, other modes of operation may also be achieved by leveraging one or more of the first microwave supply system 52, the second microwave supply system 54, and the heating system 72. For instance, a defrost mode may be selected via the user interface 86, which prompts the control unit 78 to only activate the second microwave supply system 54 such that the second and third microwave generators 56, 64 generate microwaves supplied to the cavity 14. In contrast, when an even heating mode is selected via the user interface 86, the control unit 78 only activates both the first and second microwave supply systems 52, 54 such that the first, second, and third microwave generators 22, 56, 64 generate microwaves supplied to the cavity 14. In contrast still, when a controlled heating mode is selected via the user interface 86, the control unit 78 only activates the second microwave supply system 54 and the heating system 72 such that the second and third microwave generators 56, 64 generate microwaves supplied to the cavity 14 and the heating element 74 provides a broiling function to the cavity 14. In further contrast, when a bottom heating mode is selected via the user interface 86, the control unit 78 only activates the first microwave supply system 52 such that the first microwave generator 22 generates microwaves supplied to the cavity 14.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the device as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned microwave oven 10 without departing from the concepts provided herein, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above is merely for illustrative purposes and not intended to limit the scope of the device, which is defined by the following claims as interpreted according to the principles of patent law, including the Doctrine of Equivalents.

1. A microwave oven comprising:
a cavity;
a first microwave supply system configured to supply microwaves to a bottom of the cavity for energizing a crisp function;
a second microwave supply system configured to supply microwaves to the cavity for exciting cavity modes;
a heating system configured to provide a broiling function to the cavity; and
a control unit configured to control the first microwave supply system, the second microwave supply system, and the heating system based on a mode of operation selected via a user interface.

2. The microwave oven as claimed in claim 1, wherein the first microwave supply system comprises a first microwave generator configured as a solid-state based microwave generator and connected to a transmission line for supplying microwaves to a rotatable antenna via a first feeding port.

3. The microwave oven as claimed in claim 1, wherein the second microwave supply system comprises a first feeding port located at an upper extent of a first side wall of the cavity, a second feeding port located at an upper extent of a second side wall of the cavity, and at least one microwave generator configured as a solid-state based microwave generator for generating microwaves supplied to the first and second feeding ports.

4. The microwave oven as claimed in claim 1, wherein the mode of operation includes a crisp mode, and wherein selection of the crisp mode prompts the control unit to activate the first microwave supply system, the second microwave supply system, and the heating system.

5. The microwave oven as claimed in claim 1, wherein the mode of operation includes a defrost mode, and wherein selection of the defrost mode prompts the control unit to only activate the second microwave supply system.

6. The microwave oven as claimed in claim 1, wherein the mode of operation includes an even heating mode, and wherein selection of the even heating mode prompts the control unit to only activate both the first and second microwave supply systems.

7. The microwave oven as claimed in claim 1, wherein the mode of operation includes a controlled heating mode, and wherein selection of the controlled heating mode prompts the control unit to only activate the second microwave supply system and the heating system.

8. The microwave oven as claimed in claim 1, wherein the mode of operation includes a bottom heating mode, and wherein selection of the bottom heating mode prompts the control unit to only activate the first microwave supply system.

9. A microwave oven comprising:
a cavity having a bottom tray;
a crisp plate in thermal contact with the bottom tray;
a first microwave supply system comprising:
a first microwave generator for generating microwaves; and
a rotatable antenna for receiving the generated microwaves via a first feeding port and supplying the generated microwaves under the bottom tray for heating a sole of the crisp plate to a Curie point;
a second microwave supply system comprising:
a second feeding port provided at a first side wall of the cavity;
a third feeding port provided at a second side wall of the cavity, the second side wall being opposite to the first side wall; and
at least one microwave generator for generating microwaves supplied to the cavity via the second and third feeding ports;
a heating system configured to provide a broiling function to the cavity; and
a control unit configured to activate the first microwave generator, the at least one microwave generator, and the heating system to provide a crisp function to the cavity.

10. The microwave oven as claimed in claim 9, wherein the first microwave generator is a solid-state based microwave generator.

11. The microwave oven as claimed in claim 9, wherein the at least one microwave generator is a solid-state based microwave generator.

12. The microwave oven as claimed in claim 9, wherein the at least one microwave generator comprises a second microwave generator for generating microwaves supplied to the cavity via the second feeding port and a third microwave generator for generating microwaves supplied to the cavity via the third feeding port.

13. The microwave oven as claimed in claim 9, wherein the heating system comprises a heating element arranged at a ceiling of the cavity.

14. The microwave oven as claimed in claim 9, further comprising a user interface with which to input information to the control unit.

15. A method of crisping a food item in a microwave oven, comprising the steps of:
providing a bottom tray in a cavity of the microwave oven;
providing a crisp plate in thermal contact with the bottom tray;
supplying microwaves to a bottom of a cavity for heating a sole of the crisp plate to a Curie point;
supplying microwaves to the cavity for exciting cavity modes; and
activating a heating system to provide a broiling function to the cavity.

16. The method as claimed in claim 15, wherein the microwaves supplied to the bottom of the cavity via a first feeding port are generated by a first microwave generator configured as a solid-state based microwave generator.

17. The method as claimed in claim 16, wherein the microwaves supplied to the bottom of the cavity are directed under the bottom tray using a rotatable antenna.

18. The method as claimed in claim 15, wherein the microwaves supplied to the cavity are generated by at least one microwave generator configured as a solid-state based microwave generator.

19. The method as claimed in claim 18, wherein the at least one microwave generator comprises a second microwave generator configured to generate microwaves supplied to the cavity via a second feeding port and a third microwave generator configured to generate microwaves supplied to the cavity via a third feeding port, the second feeding port being located at an upper extent of a first side wall of the cavity and the third feeding port being located at an upper extent of a second side wall of the cavity that is opposite to the first side wall.

20. The method as claimed in claim 15, further comprising the step of selecting a crisp mode via a user interface.
